(19) United States
(12) Patent Application Publication
(10) Pub. No.: US 2026/0086252 A1
(43) Pub. Date: Mar. 26, 2026

(54) DETECTION OF ELECTROMAGNETIC INTERFERENCE FIELDS DURING THE OPERATION OF AN X-RAY DETECTOR

(71) Applicant: Siemens Healthineers AG, Forchheim (DE)

(72) Inventor: Roland Friedrich, Erlangen (DE)

(21) Appl. No.: 19/326,308

(22) Filed: Sep. 11, 2025

(30) Foreign Application Priority Data
Sep. 24, 2024 (DE) 10 2024 209 153.7

(51) Int. Cl. G01T 1/29; H04N 23/30; H04N 23/52; H04N 25/68

(52) U.S. Cl. CPC G01T 1/29; H04N 23/30; H04N 23/52; H04N 25/68

(57) ABSTRACT

A method is described for detection of electromagnetic interference fields during the operation of an X-ray detector. In the method, a value is determined that represents a variation of successive detector signal values of a pixel of the X-ray detector not exposed to X-rays. The value is compared with a predetermined threshold value and it is determined that an interference by electromagnetic interference fields has occurred in the event that the determined value exceeds the predetermined threshold value. An interference detection facility and an X-ray detector are also described.

The present patent document claims the benefit of German Patent Application No. 10 2024 209 153.7, filed Sep. 24, 2024, which is hereby incorporated by reference in its entirety.

### TECHNICAL FIELD

The disclosure relates to a method for detection of electromagnetic interference fields during the operation of an X-ray detector. The disclosure additionally relates to an interference detection facility. The disclosure also relates to an X-ray detector.

### BACKGROUND

X-ray imaging systems are prone to electromagnetic interference fields, which may result in interference effects and in particular image artifacts in image data, which are picked up by flat-panel detectors of an X-ray imaging system. The phenomenon affects in particular X-ray detectors with a switch-matrix readout, for example, those based on amorphous silicon (“ASi”) technology or a technology with similar readout methods.

Measures have been taken in the past for electromagnetic screening of X-ray detectors. One case involves maintaining certain distances from electrical equipment or installations. However, to date, no detection of electromagnetic interference fields has been provided.

Up until now, during the evaluation of a detector signal of an X-ray detector impinged upon by X-rays, an offset-signal is subtracted from the detector signal for each pixel of the X-ray detector. For this purpose, for each pixel, a mean value of a series of detector signals of an X-ray detector not impinged upon by X-rays is calculated. This value is then deducted from the detector signal of the respective pixel of the X-ray detector exposed to X-rays. However, this does not allow factoring out of dynamic interference effects from the detector signals.

### SUMMARY AND DESCRIPTION

Thus, the object is to specify a method and a device for reducing dynamic external interference effects, in particular electromagnetic interference fields, of an X-ray imaging system or an X-ray detector.

The scope of the present disclosure is defined solely by the appended claims and is not affected to any degree by the statements within this summary. The present embodiments may obviate one or more of the drawbacks or limitations in the related art.

This object is achieved by a method for detection of electromagnetic interference fields during the operation of an X-ray detector, an interference detection facility, and an X-ray detector, as described herein.

In the method for detection of electromagnetic interference fields during the operation of an X-ray detector, a value is determined that represents a variation in successive detector signal values of at least one pixel of the X-ray detector not exposed to X-rays.

This may mean either a pixel or a pixel group, the measured value of which has been determined without impingement by X-rays, or a pixel group, that during the impingement of the detector by X-rays was covered with a screening material (e.g., lead, tungsten, etc.).

A variation shall be understood to be a measure of a temporary change, in particular an oscillation behavior of a functional value, in particular of a detector signal value. Such a detector signal value has in particular a signal amplitude, which may be subject to fluctuations due to interferences. An electromagnetic interference field shall be understood to be an electromagnetic field whose effect on the operation of the X-ray detector through emission, radiation, induction, or a combination thereof on the X-ray detector causes an undesired effect on the measurement by the X-ray detector. In particular, a variation in an offset of a detector signal is caused, which may contribute to undesired measurement fluctuations. The electromagnetic interference field may be an external interference field that does not originate from the X-ray source, which impinges the X-ray detector with X-rays, to generate X-ray projection data or image data.

A pixel of an X-ray detector shall be understood to be a sensor surface of a group of sensor surfaces arranged adjacently on a sensor field. A separate sensor signal may be assigned to each of the pixels.

The value determined is compared with a predetermined threshold value. The predetermined threshold value indicates a maximum value that may not be exceeded. The threshold value depends on the technology of the X-ray detector and its interference sensitivity. To determine the threshold value, detector type-specific tests are performed to determine up to which threshold value an interference effect due to an interference field may still be tolerated.

It is then determined that interference due to electromagnetic interference fields occurs, in the event that the value determined exceeds the predetermined threshold value. Otherwise, it is considered that no electromagnetic interference field occurs and, if necessary, in a subsequent imaging based on detector signals, image data is generated and output. Advantageously, the occurrence of an interference field is detected so that it may be avoided that an incorrect offset value of a detector signal is measured or generally that measured values distorted by the interference field are detected and processed. The user may then be informed and/or warned in good time and it is avoided that image data afflicted by artifacts is detected, which is then rejected. Unnecessary repetition of X-ray imaging may then be prevented and thus increased radiation exposure due to the repeated X-ray imaging may be avoided.

The interference detection facility has an input interface for receiving detector signals of one or more pixels of an X-ray detector. The interference detection facility also includes a variation determination unit for determining a value that represents a variation in successive detector signal values of at least one pixel of the X-ray detector not exposed to X-rays.

Also, part of the interference detection facility is a comparison unit for comparing the value with a predetermined threshold value.

Moreover, the interference detection facility includes an interference determination unit for determining the occurrence of interference by electromagnetic interference fields, in the event that the value determined exceeds the predetermined threshold value. The interference detection facility shares the advantages of the method for detection of electromagnetic interference fields during the operation of an X-ray detector.

The X-ray detector has a detector unit with a plurality of detector pixels, an interference detection facility, and an evaluation unit configured to evaluate detector signals from the detector unit, in the event that the interference detection facility has determined that no interference by electromagnetic interference fields has occurred. The X-ray detector has the advantages of the interference detection facility described herein.

The majority of the abovementioned components of the interference detection facility may be implemented in full or in part in the form of software modules in a processor of a corresponding computer system, for example, of a control facility of an X-ray imaging system or X-ray detector or a computer, used to control such a system. A largely software-based implementation has the advantage that previously used computer systems may also be easily retrofitted with a software update, in order to work in the manner.

In this respect, the object is also achieved by a corresponding computer program product with a computer program, which may be loaded directly into a computer system, with program sections, for carrying out the acts of the method for detection of electromagnetic interference fields during the operation of an X-ray detector, if the program is executed in the computer system. Such a computer program product may include as necessary, in addition to the computer program, additional parts such as documentation and/or additional components, as well as hardware components, such as dongles etc., for using the software.

For transport to the computer system and/or for storing on or in the computer system, a (non-transitory) computer-readable medium, (e.g., a memory stick, a hard disk, or other transportable or integral data carrier may be used), on which the program sections of the computer program readable and executable by a computer system are stored. To this end, the computer system may have one or more cooperating microprocessors or similar.

The claims and the following description respectively contain particularly advantageous embodiments and developments of the disclosure. In particular, the claims of one claim category may also be developed analogously to the claims of another claim category. Furthermore, in the context of the disclosure, the various features of different exemplary embodiments and claims may also be combined into new exemplary embodiments.

In a variant of the method for detection of electromagnetic interference fields during the operation of an X-ray detector during the determining of the value, a value of a variation per pixel is determined. Then, during the comparing of the value, the value is compared with a predetermined threshold value and during the determining of a possible interference, it is determined that interference by electromagnetic interference fields has occurred, in the event that one of the determined values exceeds the predetermined threshold value. With this variant, a determination of a variation by pixel of an X-ray detector takes place, so that it may be determined with great accuracy which partial area of an X-ray detector an electromagnetic interference field is affecting.

In a variant of the method for detection of electromagnetic interference fields during the operation of an X-ray detector in the comparison, based on the determined values per pixel of the variation, in each case a mean value of the variation is determined over a plurality of pixels. The mean value is compared with a predetermined threshold value. In the determining of a possible interference, it is then determined that interference by electromagnetic interference fields has occurred, in the event that the mean value exceeds the predetermined threshold value. Advantageously, interferences that may only concern individual pixels and are probably intrinsic, are compensated by the averaging.

In an embodiment of the method for detection of electromagnetic interference fields, the variation of successive detector signal values includes a variance of successive detector signal values of an X-ray detector not exposed to X-rays. Variance of successive detector signal values means a distribution of these detector signal values about a mean value. The variance is given by the sum of the squares of the deviations of the detector signal values from the arithmetic mean of the detector signal values divided by the number of detector signal values. The variance is a measure of the distribution of values about a mean value.

In an embodiment of the method for detection of electromagnetic interference fields, the variation of successive detector signal values includes a standard deviation of successive detector signal values of an X-ray detector not exposed to X-rays. Standard deviation means the square root of the variance of the successive detector signal values. If the distribution of the detector signal values follows a normal distribution, then 68 percent of the detector signal values lie within the standard deviation.

In an alternative embodiment of the method, the value represents a variation of successive detector signal values of a group of pixels of the X-ray detector. Advantageously, the determination of the variation measured values includes an entire group of pixels, so that measurement errors related to defects in individual pixels may be compensated.

In this variant, during the determining of a value of a variation of successive detector signal values, location-specific mean values of simultaneously detected detector signal values are determined for the group of pixels and the value of the variation is determined based on the mean values. During the comparison, the value is compared with a predetermined threshold value and during the determining of a possible interference, it is determined that interference by electromagnetic interference fields has occurred, in the event that one of the determined values exceeds the predetermined threshold value. In this variant, the variation is determined on the basis of mean values of detector signals. In this variant, design-related deviations in individual pixels may also be factored out. However, the variation only has to be calculated once, i.e., based only on the mean values.

In this variant, the variation may include a variance of location-specific mean values of simultaneously detected detector signal values for the group of pixels, if a variance is to be calculated as a comparative value.

Alternatively, the variation has a standard deviation of location-specific mean values of simultaneously detected detector signal values for the group of pixels, if a standard deviation is to be calculated as a comparative value.

In a variant of the method, during the comparison, based on the values of the variation determined for each group of pixels, in each case a mean value of the variation is determined over a plurality of groups of pixels and the mean value is compared with a predetermined threshold value. Advantageously, a broad inclusion of pixels in the determination of the comparative value takes place. Then, during the determining of a possible interference, it is determined that an interference by electromagnetic interference fields has occurred, in the event that the mean value exceeds the predetermined threshold value.

Advantageously, a user is informed, in particular warned, of the interference, if during the method an interference has been determined. The user may be advantageously informed or warned via a user interface, in particular an optical and/or acoustic signal. The advantage of such user information or warnings is that the user may respond appropriately to these before recording medical image data with the X-ray detector, for example by repositioning devices generating the interference fields.

An advantageous embodiment of the interference detection facility has a user interface, in particular an optical and/or acoustic signal, designed to inform a user of an interference, that may be or has been determined by a method.

### BRIEF DESCRIPTION OF THE DRAWINGS

In the following, the disclosure is explained in further detail with reference to the attached figures based on exemplary embodiments.

FIG. 1 depicts a flow chart illustrating a method for detection of electromagnetic interference fields during the operation of an X-ray detector, according to an exemplary embodiment.

FIG. 2 depicts a schematic representation of an interference detection facility, according to an exemplary embodiment.

FIG. 3 depicts a schematic representation of an X-ray detector system, according to an exemplary embodiment.

### DETAILED DESCRIPTION

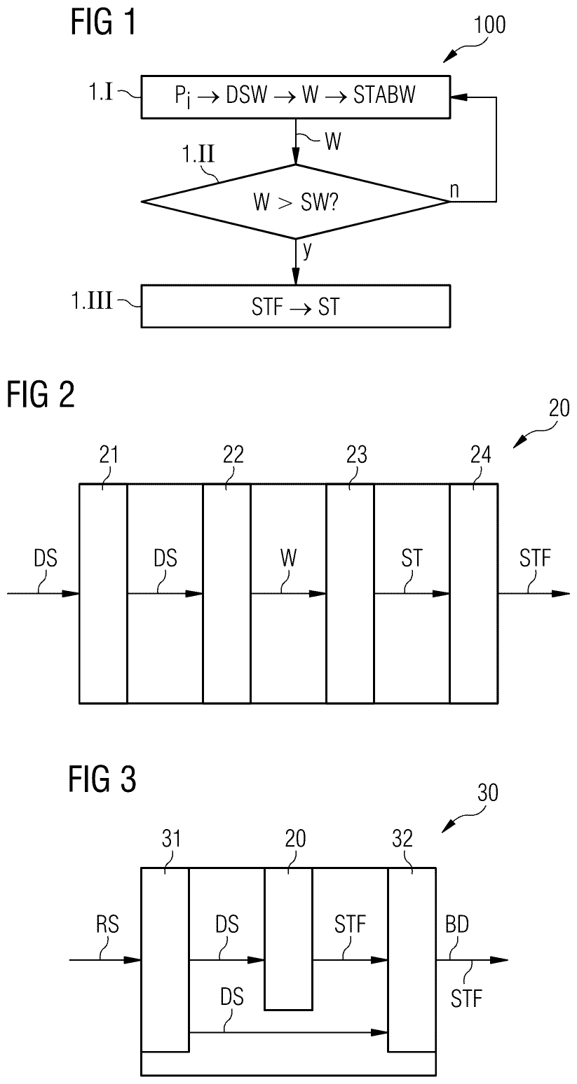

In FIG. 1, a flow diagram 100 is shown, which illustrates a method for detection of electromagnetic interference fields STF during the operation of an X-ray detector 30 (see FIG. 3) according to an exemplary embodiment.

In act 1.I, a value W is determined. The value represents a standard deviation STABW of successive detector signal values DSW of a group of pixels Pᵢ of the X-ray detector 30 not exposed to X-rays.

In act 1.II, the value W is compared with a predetermined threshold value SW.

In the event that in act 1.II it has been determined that the predetermined threshold value SW has been exceeded, identified in FIG. 1 by “y,” then the method moves to act 1.III in which it is determined that an interference ST by electromagnetic interference fields STF has occurred. In the event that in act 1.II it has been determined that the predetermined threshold value SW has not been exceeded, identified in FIG. 1 by “n,” then the method returns to act 1.I, and signals of adjacent groups or pixels Pᵢ or the same group of pixels Pᵢ again are investigated at a later point in time.

In FIG. 2, a schematic representation of an interference detection facility 20 according to an exemplary embodiment is shown.

The interference detection facility 20 includes an input interface 21 for receiving detector signals DS of one or more pixels Pᵢ of an X-ray detector 30 (see FIG. 3).

Also, part of the interference detection facility 20 is a variation determination unit 22 for determining a value W, which represents a standard deviation STABW of successive detector signal values of a pixel Pᵢ of the X-ray detector 30 not exposed to X-rays.

The interference detection facility 20 also includes a comparison unit 23 for comparing the value W with a predetermined threshold value SW. In the event that the threshold value SW is exceeded by the value W or the value of the standard deviation STABW, a warning of an interference ST is generated.

The interference detection facility 20 also includes an interference determination unit 24 for determining that an interference by electromagnetic interference fields STF has occurred, in the event that an interference ST has been determined.

In FIG. 3, a schematic representation of an X-ray detector 30 according to an exemplary embodiment is illustrated. The X-ray detector 30 itself is designed to detect X-rays RS impinging upon it.

The X-ray detector 30 has a detector unit 31 with a plurality of detector pixels. Also, part of the X-ray detector 30 is an interference detection facility 20 as shown in FIG. 2, which is configured.

The X-ray detector 30 also includes an evaluation unit 32, configured to evaluate detector signals DS from the detector unit 31, in the event that the interference detection facility 20 has determined that no interference by electromagnetic interference fields has occurred and to generate image data BD on the basis of detector signals or in the event of occurrence of an interference to issue an interference notification in respect of an interference field STF.

Finally, reference is also made once more to the fact that the method and devices described above merely relate to exemplary embodiments of the disclosure and that the disclosure may be varied by the person skilled in the art, without deviating from the field of the disclosure, insofar as this is specified by the claims. For the sake of completeness, it is also stated that use of the indefinite article “a” does not exclude the features concerned also being present multiple times. Similarly, the term “unit” does not exclude this including multiple components that may also be spatially distributed. Independent of the grammatical term usage, individuals with male, female or other gender identities are included within the term.

1. A method for detection of electromagnetic interference fields during operation of an X-ray detector, the method comprising:
determining a value that represents a variation of successive detector signal values of at least one pixel of the X-ray detector not exposed to X-rays;
comparing the value with a predetermined threshold value; and
determining that an interference by electromagnetic interference fields has occurred when the value determined exceeds the predetermined threshold value.

2. The method as claimed in claim 1, wherein the determining of the value comprises determining a value of a variation per pixel to provide determined values,
wherein the determined values are compared with the predetermined threshold value, and
wherein the interference by the electromagnetic interference fields has occurred when at least one of the determined values exceeds the predetermined threshold value.

3. The method of claim 2, wherein, based on the value of the variation determined for each pixel, a mean value is determined over a plurality of pixels,
wherein the mean value is compared with the predetermined threshold value, and
wherein the interference by the electromagnetic interference fields has occurred when the mean value exceeds the predetermined threshold value.

4. The method of claim 3, wherein the variation of the successive detector signal values comprises a variance of the successive detector signal values of the X-ray detector not exposed to the X-rays.

5. The method of claim 3, wherein the variation of the successive detector signal values comprises a standard deviation of the successive detector signal values of the X-ray detector not exposed to the X-rays.

6. The method of claim 1, wherein the variation of the successive detector signal values comprises a variance of the successive detector signal values of the X-ray detector not exposed to the X-rays.

7. The method of claim 1, wherein the variation of the successive detector signal values comprises a standard deviation of the successive detector signal values of the X-ray detector not exposed to the X-rays.

8. The method of claim 1, wherein the value represents a variation of successive detector signal values of a group of pixels of the X-ray detector.

9. The method of claim 8, wherein location-specific mean values of simultaneously detected detector signal values are determined for the group of pixels and the value of the variation is determined based on the location-specific mean values.

10. The method of claim 9, wherein the variation comprises a variance of the location-specific mean values of the simultaneously detected detector signal values for the group of pixels.

11. The method of claim 9, wherein the variation comprises a standard deviation of the location-specific mean values of the simultaneously detected detector signal values for the group of pixels.

12. The method of claim 9, wherein, based on the values of the variation determined for each group of pixels, a mean value is determined over a plurality of groups of pixels,
wherein the mean value is compared with the predetermined threshold value, and
wherein the interference by the electromagnetic interference fields has occurred when the mean value exceeds the predetermined threshold value.

13. An interference detection facility comprising:
an input interface for receiving detector signals of at least one pixel of an X-ray detector;
a variation determination unit for determining a value that represents a variation of successive detector signal values of at least one pixel of the X-ray detector not exposed to X-rays;
a comparison unit for comparing the value with a predetermined threshold value; and
an interference determination unit for determining that an interference by electromagnetic interference fields has occurred when the value determined exceeds the predetermined threshold value.

14. The interference detection facility of claim 13, further comprising:
a user interface, in particular an optical signal and/or an acoustic signal, configured to inform a user of the interference determined by the interference determination unit.

15. An X-ray detector comprising:
a detector unit with a plurality of detector pixels;
an interference detection facility comprising: an input interface for receiving detector signals of at least one pixel of the X-ray detector; a variation determination unit for determining a value that represents a variation of successive detector signal values of at least one pixel of the X-ray detector not exposed to X-rays; a comparison unit for comparing the value with a predetermined threshold value; and an interference determination unit for determining that an interference by electromagnetic interference fields has occurred when the value determined exceeds the predetermined threshold value; and
an evaluation unit configured to evaluate the detector signals of the detector unit when the interference detection facility has determined that no interference by the electromagnetic interference fields has occurred.
